(19) United States
(12) Patent Application Publication
(10) Pub. No.: US 2010/0223332 A1
(43) Pub. Date: Sep. 2, 2010

(54) SYSTEMS AND METHODS FOR IMPLEMENTING RELIABLE NEIGHBORCAST PROTOCOL

(75) Inventors: Nicholas F. Maxemchuk, Mountainside, NJ (US); Patcharinee Tientrakool, Woodside, NY (US); Theodore L. Willke, Tacoma, WA (US)

Correspondence Address: BAKER BOTTS L.L.P., 30 ROCKEFELLER PLAZA, 44TH FLOOR, NEW YORK, NY, 10112-4498, US

(73) Assignee: THE TRUSTEES OF COLUMBIA UNIVERSITY IN THE CITY OF NEW YORK, New York, NY (US)

(21) Appl. No.: 12/615,907

(22) Filed: Nov. 10, 2009

Related U.S. Application Data
(63) Continuation of application No. PCT/US2008/063467, filed on May 12, 2008.
(60) Provisional application No. 60/917,568, filed on May 11, 2007.

(51) Int. Cl. G06F 15/16

(52) U.S. Cl. 709/204

(57) ABSTRACT

Methods and systems for vehicle-to-vehicle communications where vehicles can communicate one or more of speed, position, direction, acceleration and state in order to coordinate or control their operation are disclosed herein. In some embodiments of the disclosed subject matter, methods for vehicle-to-vehicle communications where vehicles can communicate one or more of speed, position and state in order to coordinate or control their operation. An exemplary method includes creating moving broadcasting groups which groups can move with the flow of traffic, adjust the span of the group and maintain minimum overlap size between adjacent broadcasting groups, combining two or more vehicles within one or more broadcasting groups, within some specified distance into neighborhoods, transmitting information about one or more of speed, position and state of vehicles in the neighborhood to the other vehicles in said neighborhood; receiving information about speed, position and state by vehicles in the neighborhood from the other vehicles in said neighborhood, filtering out duplicate information and information received from vehicles that are not in the same neighborhood, providing that two or more vehicles in the same neighborhood have substantially continuous communication capacity by maintaining the size of overlap between adjacent neighborhoods, avoiding delays in entering the new neighborhood by extending the overlap size, and utilizing one or more guarantees provided by an underlying reliable broadcast communication layer by transferring said guarantees to corresponding one or more neighborhoods.

### CROSS REFERENCE TO RELATED APPLICATIONS

This application is a continuation of International Application No. PCT/US2008/063467 entitled “Systems And Methods For Implementing Reliable Neighborcast Protocol”, filed May 12, 2008, which claims priority to U.S. Provisional Application No. 60/917,568 entitled “Reliable Neighborcast” filed on May 11, 2007, which are incorporated by reference in their entirety herein.

### BACKGROUND

The present application relates to systems and methods for implementing a protocol for use in vehicle-to-vehicle communications networks.

Vehicle-to-vehicle networks use wireless links to communicate between nearby trains, planes or automobiles. Vehicle-to-vehicle applications can provide warnings to the operator of the vehicle (for instance there can be an obstacle behind the vehicle while backing up), can control external devices, such as traffic signals, or can directly control the operation of the vehicle. Many applications can be implemented with sensors alone, without vehicle-to-vehicle communications, however, the applications can almost always be improved by using information from sensors in nearby vehicles. The applications can be further improved by providing information that can not yet be detected by sensors. With vehicle-to-vehicle communications, a vehicle can provide a warning when the driver in front of it first steps on his brakes, before his car actually slows down. When drivers control vehicles, such communications can be used to negotiate an operation. For instance, if the vehicle is stopping and the truck behind it cannot stop as quickly, this vehicle can be prevented from stopping too quickly.

The guarantees provided by communications protocols and the message delay determine the type of operations a vehicle can perform, and how well the applications can perform. Some of the applications are currently being implemented using protocols with weak guarantees (i.e. guaranteed delivery, bounded delay, consistent message sequencing, and knowledge of when all other vehicles have a message). Thus, there is a need for a protocol with stronger guarantees.

Several of the related protocols require communications devices along highways. These proposals require a considerable investment in infrastructure before the value of the applications can be demonstrated or realized. Consequently, there is a need for protocols that can operate on infrastructure-less, ad hoc networks which make it possible to demonstrate the advantages without investing in new infrastructure.

### SUMMARY

In accordance with the disclosed subject matter herein, methods and systems for vehicle-to-vehicle communications are provided, where vehicles can communicate one or more of speed, position, direction, acceleration and state in order to coordinate or control their operation.

In some embodiments of the disclosed subject matter, methods for vehicle-to-vehicle communications where vehicles can communicate one or more of speed, position, direction, acceleration and state in order to coordinate or control their operation. An exemplary method includes creating moving broadcasting groups which groups can move with the flow of traffic, adjust the span of the group and maintain minimum overlap size between adjacent broadcasting groups, combining into neighborhoods two or more vehicles within one or more broadcasting groups, within a specified distance from vehicles that currently assume the role of centers for said neighborhoods, transmitting information about one or more of speed, position, direction, acceleration and state of vehicles in a neighborhood to the other vehicles in the neighborhood, receiving information about speed, position, direction, acceleration and state transmitted by vehicles in the neighborhood from the other vehicles in said neighborhood, filtering out by vehicles that currently assume the role of centers, duplicate information and information received from vehicles that are not in the same neighborhood, providing that vehicles that currently assume the role of centers and one or more vehicles in the same neighborhood have substantially continuous communication capacity by maintaining the size of overlap between adjacent neighborhoods, avoiding delays in entering the new neighborhood by extending the overlap size, and utilizing one or more guarantees provided by an underlying reliable broadcast communication layer by transferring the guarantees to corresponding one or more neighborhoods.

In some embodiments, delivery of information about speed, position, direction, acceleration and state of a vehicle to one or more vehicle in the same neighborhood is guaranteed.

In some embodiments, information about speed, direction, position and state of a vehicle is further transmitted among vehicles in the neighborhoods over wireless channels of infrastructure-less, ad hoc networks.

In some embodiments, information is transmitted among vehicles in the neighborhoods as individual messages.

In some embodiments, individual messages are received by one or more vehicles in the same neighborhood are further sequenced in the same order.

In some embodiments, an underlying reliable broadcast communication layer provides two levels of guarantees using a timed token passing mechanism strategy.

In some embodiments, inconsistencies that occur with a timed token passing mechanism strategy are resolved by a distributed voting procedure.

In some embodiments of the disclosed subject matter, systems for vehicle-to-vehicle communications where vehicles can communicate speed, position, direction and/or state in order to coordinate or control their operation. An exemplary system includes a vehicle, a processing unit operatively coupled to the vehicle, a wireless connection device operatively coupled to the processing unit, a global navigation satellite positioning device operatively coupled to the processing unit, sensors for vehicle speed, direction, position, acceleration and state operatively coupled to the processing unit, and a memory operatively coupled to the processor unit. In this exemplary system, the memory functions to store received messages and program instructions that, when executed by the processor, cause the processor to utilize the wireless connection device to create moving broadcasting groups, which groups can move with the flow of traffic, adjust the span of the group and maintain minimum overlap size between adjacent broadcasting groups, combine into neighborhoods two or more vehicles within one or more broadcasting groups, within some specified distance from vehicles that currently assume the role of centers for said neighborhoods, transmit information about one or more of speed, position, direction, acceleration and state of vehicles in the neighborhood to the other vehicles in the same neighborhood, receive information about speed, position, direction, acceleration and state by vehicles in the neighborhood from the other vehicles in said neighborhood, filter out by vehicles that currently assume the role of centers, duplicate information and information received from vehicles that are not in the same neighborhood, provide that vehicles that currently assume the role of centers and one or more vehicles in the same neighborhood have substantially continuous communication capacity by maintaining the size of overlap between adjacent neighborhoods, avoid delays in entering the new neighborhood by extending the overlap size, and utilize one or more guarantees provided by an underlying reliable broadcast communication layer by transferring said guarantees to corresponding one or more neighborhoods.

In some embodiments, delivery of information about one or more of speed, position, direction, direction, acceleration and state to one or more vehicles in the same neighborhood is guaranteed.

In some embodiments, the information about one or more of speed, position, direction, acceleration and state is transmitted among vehicles in the neighborhoods over wireless channels of infrastructure-less, ad hoc networks. In some embodiments, information is further transmitted among vehicles in the neighborhoods as individual messages.

In some embodiments, the exemplary system guarantees that the same individual messages are received by one or more vehicles in the same neighborhood, and they are sequenced in the same order.

In some embodiments, an underlying reliable broadcast communication layer provides two levels of guarantees using a timed token passing mechanism strategy. In some embodiments, inconsistencies that occur with said strategy are resolved by a distributed voting procedure.

In some embodiments of the disclosed subject matter, systems for vehicle-to-vehicle communications where vehicles can communicate speed, position, direction and/or state in order to coordinate or control their operation. In this exemplary system, means are utilized for creating moving broadcasting groups, which groups can move with the flow of traffic, adjust the span of the group and maintain minimum overlap size between adjacent broadcasting groups, means are utilized for combining into neighborhoods two or more vehicles within one or more broadcasting groups, within some specified distance from vehicles that currently assume the role of centers for said neighborhoods, means are utilized for transmitting information about one or more of speed, position, direction, acceleration and state of vehicles in the neighborhood to the other vehicles in the same neighborhood, means are utilized for receiving information about speed, position, direction, acceleration and state by vehicles in the neighborhood from the other vehicles in said neighborhood, means are utilized for filtering out by vehicles that currently assume the role of centers, duplicate information and information received from vehicles that are not in the same neighborhood, means are utilized for providing that vehicles that currently assume the role of centers and one or more vehicles in the same neighborhood have substantially continuous communication capacity by maintaining the size of overlap between adjacent neighborhoods, means are utilized for avoiding delays in entering the new neighborhood by extending the overlap size, and means are utilized for utilizing one or more guarantees provided by an underlying reliable broadcast communication layer by transferring said guarantees to corresponding one or more neighborhoods.

In some embodiments, delivery of information about one or more of speed, position, direction, direction, acceleration and state to one or more vehicles in the same neighborhood is guaranteed.

In some embodiments, the information about one or more of speed, position, direction, acceleration and state is transmitted among vehicles in the neighborhoods over wireless channels of infrastructure-less, ad hoc networks. In some embodiments, information is further transmitted among vehicles in the neighborhoods as individual messages.

In some embodiments, the exemplary system guarantees that the same individual messages are received by one or more vehicles in the same neighborhood, and they are sequenced in the same order.

In some embodiments, an underlying reliable broadcast communication layer provides two levels of guarantees using a timed token passing mechanism strategy. In some embodiments, inconsistencies that occur with said strategy are resolved by a distributed voting procedure.

### BRIEF DESCRIPTION OF THE DRAWINGS

The accompanying drawings, which are incorporated and constitute part of this disclosure, illustrate some exemplary embodiments of the disclosed subject matter.

FIG. 1 illustrates an overlap of neighborhoods for nearby vehicles in accordance with an embodiment of the disclosed subject matter.

FIG. 2 illustrates the behavior of a token ring of receivers used in an underlying mobile reliable broadcast protocol (M-RBP) in accordance with an embodiment of the disclosed subject matter.

FIG. 3 illustrates overlapping broadcast groups, with evenly-spaced vehicles, in a 1-D network in accordance with an embodiment of the disclosed subject matter.

FIG. 4 illustrates a general 1-D network in accordance with an embodiment of the disclosed subject matter.

FIG. 5 illustrates a neighborhood and group partitions in accordance with an embodiment of the disclosed subject matter.

FIG. 6 illustrates a situation where vehicles change broadcast groups when the overlap is extended by C in accordance with an embodiment of the disclosed subject matter.

FIG. 7 shows a graph illustrating two-dimensional reliable neighborcast and the underlying broadcast groups in accordance with an embodiment of the disclosed subject matter.

### DETAILED DESCRIPTION

The disclosed subject matter provides new techniques for vehicle-to-vehicle communications, where vehicles communicate with nearby vehicle to form a neighborhood. Each vehicle's neighborhood is distinct from, and can overlap with, that of other vehicles. Communication is not contained in a well-defined group of vehicles, as in broadcast and multicast, but is spread over a large area. The disclosed subject matter guarantees that messages are delivered to all of the vehicle's neighbors that are equipped to be a part of network.

The disclosed subject matter provides technique for exchanging information among vehicles. This information can include but is not limited to speed, position, direction, acceleration and state of vehicles. Speed and state of a vehicle can be obtained from one or more sensors built into transmission or any other suitable place in the vehicle. Position and direction of the vehicle can be obtained by utilizing a Global Positioning System (GPS), the mobile communication network or any other similar positioning system as long as it provides required precision.

In the context of the disclosed subject matter, a “neighborhood” means a set of nearby vehicles. Each vehicle can form a set of nearby vehicles (neighborhood) with which it wants to reliably communicate. To define the neighborhood of a vehicle, this vehicle assumes the role of the center of its neighborhood. All other vehicles up to some specified distance behind it and some specified distance in front of it assume the role of its neighbors and are included in its neighborhood. So each vehicle has two roles in the network. It has the role of the center of its own neighborhood and has the role of a neighbor of other vehicles from different neighborhoods. Each vehicle can be a message source and a receiver. As a message source, the vehicle wants all the vehicles in its neighborhood to successfully receive its messages. As a receiver, the vehicle only stores and processes messages received from the vehicles in its neighborhood.

In the context of the disclosed subject matter, “creating moving broadcasting groups” means creating a group that moves with a traffic by a vehicle that is not covered by any other existing broadcasting group. The vehicle can create a group by locating itself at the center of the group. Then the vehicle periodically transmits a token with information which indicates a center and span of the group as an invitation to other vehicles to join the group. Other vehicles that received the said token, compare their locations and the location of the group. If their locations are covered by the group span, then they send a request to join the group by using the same joining process as disclosed in M-RBP description. To be admitted to the group, the vehicles send a join request message to the group first and then wait until the voting procedure required for acceptance is complete. A moving broadcasting group is created by a vehicle that is covered by only one group and its location is within the minimum overlap size from the boundary of the group. The vehicle uses the same procedure described above to create a second group that overlaps with the first group by the minimum overlap size.

In the context of the disclosed subject matter, a “moving broadcast group” means a broadcast group that spans a region in the network and moves according to the speed of its members. All vehicles whose positions are covered by the span of a broadcast group become members of the group. A vehicle can be covered by more than one group. It becomes a member of all the groups that cover its position. As a message source, a vehicle transmits a message by broadcasting it to all the groups in which it is a member. All other members in those groups will receive the message. As a receiver, the vehicle receives messages from all the groups in which it is a member.

In the context of the disclosed subject matter, a “state of the vehicle” means the current condition of the vehicle. This term depends on the application that is running at the vehicle. For example, in collision avoidance application, the vehicle is in abnormal state when it has an engine problem. The vehicle in abnormal state can communicate its current state to other vehicles to warn them and avoid possible collisions.

In the context of the disclosed subject matter, a “guarantee” provided by a reliable broadcast communication system means an ability to achieve something, make something happen, or get something done. For example, a message delivery guarantee means an ability to successfully deliver a message to all intended receivers.

In the context of the disclosed subject matter, an “infrastructure-less, ad hoc network” refers to a network that relies only on the capabilities of nodes and equipment installed within the nodes in the network. The network does not rely on any infrastructure or equipment installed elsewhere in the network. The network is formed based on the number of nodes and locations of nodes in the network at that time without any pre-designed network topology.

In the context of the disclosed subject matter, a “timed token passing mechanism strategy” refers to a strategy under which nodes in a broadcast group take turn to transmit a token according to a specified order. Each node transmits the token at its scheduled time. It does not wait for the token from the previous node before transmitting its token to the next node in a sequence.

In the context of the disclosed subject matter, a “distributed voting procedure” means a procedure that allows nodes in a broadcast group to vote whether they have received a token from a scheduled node or not. The procedure is used to decide whether to store and use the token. It is also used to identify and remove the nodes that have already left the group. Each node collects votes received from other nodes in the group and makes its own decision about the vote result based on its received votes. Since each node makes the decision independently, the process is said to be distributed. There is no central unit that provides the vote result. The voting procedure is also used in similar manner to vote whether the nodes have received a source message and to decide whether to store and use the message.

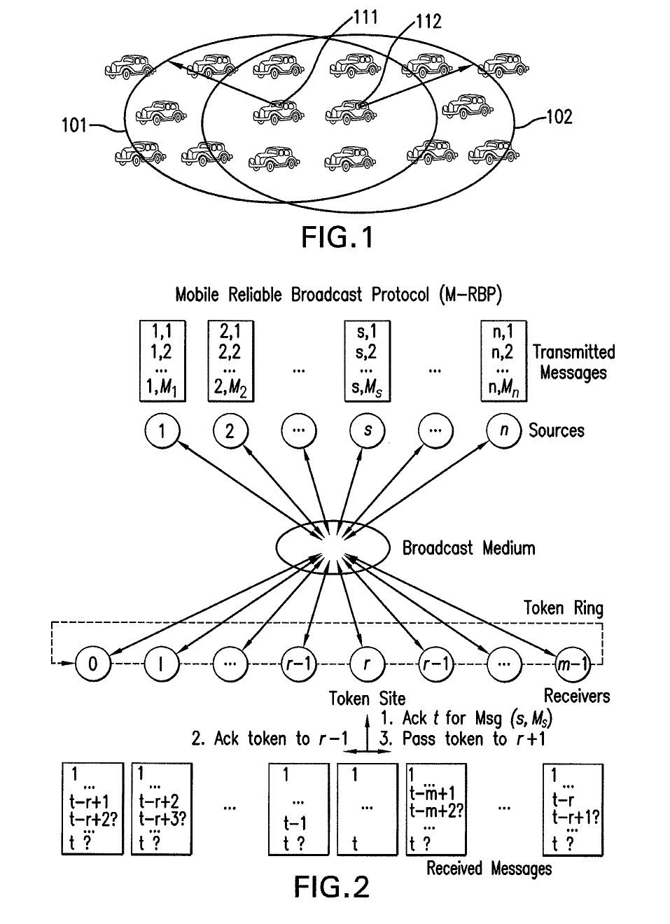

Each vehicle communicates with a set of nearby vehicles, referred to as neighborhood. The neighborhoods for nearby vehicles overlap, but can be different. FIG. 1 shows the exemplary network of two overlapping neighborhoods, 101 and 102. The communications group for e.g. exemplary vehicle 111 or 112 is different than that of the vehicle's neighbors, so the neighbors can communicate with different vehicles than the first vehicle, and the neighbor's neighbors communicate with different vehicles than the neighbor.

The communications environment for vehicle-to-vehicle applications can be demanding. Communications is over wireless links that have much less bandwidth and much higher error rates than wired networks. The bandwidth constraints and the nature of radio transmission lead us to use broadcast rather than point-to-point links between neighbors. The error rates mandate efficient message recovery procedures. Finally, the vehicles in the applications continuously move with respect to one another and change the neighborhoods.

In one aspect of the disclosed subject matter, a protocol referred to as the reliable neighborcast protocol (RNP) is provided. The RNP can provide guarantees such as message delivery, sequencing, and minimizes delay. RNP is constructed as an overlay on multiple overlapping reliable broadcast protocols. As further described below, the efficacy of the overlay is determined by the fraction of the received messages that are new messages in a participant's neighborhood.

RNP can be constructed on top of any reliable broadcast protocol. For example RNP can be constructed on top of the mobile reliable broadcast protocol (M-RBP). M-RBP provides reliable delivery and consistent message sequencing between all members of a broadcast group. It is efficient in terms of the number of control messages required per broadcast message. Unlike earlier reliable broadcast protocols, M-RBP has a dynamically changing broadcast group, which makes it well suited to mobile applications.

The disclosed subject matter also provides for the construction of efficient overlays that can pass guarantees from the underlying broadcast groups to each of the neighborhoods. In the mobile environment, the membership in the broadcast groups and the neighborhoods continuously change because vehicles move with respect to one another. A self-organizing protocol that moves broadcast groups with the general flow of vehicles and manages changes in the number and size of the broadcast groups is described below.

Vehicle-to-vehicle applications can provide warnings of impending danger to the operator, can control external devices such as traffic signals, or can directly control the operation of a vehicle. There is reluctance by drivers to give up control of their vehicles, but considering the acceptance of antilock brakes and the willingness to let technology parallel park our cars, automatic control will be accepted as its value is demonstrated.

RNP can operate on top of any reliable broadcast protocol and can provide the guarantees of that protocol to neighborhoods. M-RBP can provide a set of guarantees that is useful in vehicle applications, and has characteristics that are needed in mobile networks. RNP operates as an overlay on M-RBP.

M-RBP can guarantee the delivery of all of the source messages to all of the receivers, places the source messages in the same sequence at each receiver, and informs the receivers when all of the other receivers have the message. It provides the guarantees with as little as one acknowledgment per source message, independent of the number of receivers, by a receiver token passing mechanism that was first used in RBP. It also provides delay guarantees by using a timed token passing mechanism first described for T-RMP. There are two levels of delay guarantees as follows: one happens in a very short time and the other happens in a longer time. In a very short time, approximately equal to twice the time needed to recover a single message, M-RBP can guarantee that all of the receivers that are still in the broadcast group have received a source message. In a longer time, proportional to the number of receivers in the broadcast group, M-RBP provides a list of the receivers that were in the group and have the message. The tradeoff between delay and delivery guarantees makes M-RBP useful for a wide range of applications.

M-RBP can guarantee the delivery of all of the source messages to all of the receivers, places the source messages in the same sequence at each receiver, and informs the receivers when all of the other receivers have the message. It can provide the guarantees with as little as one acknowledgment per source message, independent of the number of receivers, by a receiver token passing mechanism that was first used in RBP. It also provides delay guarantees by using a timed token passing mechanism first described for T-RMP. There are two levels of delay guarantees as follows: one happens in a very short time and the other happens in a longer time. In a very short time, approximately equal to twice the time needed to recover a single message, M-RBP guarantees that all of the receivers that are still in the broadcast group have received a source message. In a longer time, proportional to the number of receivers in the broadcast group, M-RBP provides a list of the receivers that were in the group and have the message. The tradeoff between delay and delivery guarantees makes M-RBP useful for a wide range of applications.

FIG. 2 shows an exemplary token ring of receivers suitable for use by M-RBP. The m receivers take turns as the acknowledging site by passing a token every Δ_{T} second. When a receiver passes the token, it transmits a control message with a unique sequence number. The control message contains an acknowledgment for all received source messages that have not been previously acknowledged. The source messages have a unique identifier. The sequence number assigned to the source message is the composition of the control message sequence number and its position in the control message list. All receivers recover missing control messages. When the receivers recover the missing control messages, they place the source messages in the same order.

In M-RBP, a receiver assumes the token at its scheduled time, whether it receives the control message from the previous token site. When a token site does not recover a missing control message before transmitting its own control message, it can acknowledge source messages that were previously acknowledged, and source messages can receive several sequence numbers. When multiple control messages sequence the same message, the lower-numbered sequence number takes precedence at each receiver, and unique sequencing is preserved.

Aggressive token passing, rather than waiting to receive a token, allows M-RBP to continue to operate when receivers leave the group. The receivers use a distributed voting procedure to determine when a receiver that was scheduled to send the control message has left the group. When the vote is complete, if a majority of receivers vote that a receiver failed to transmit a control message, all of the receivers remove that receiver from the token list, and the protocol continues to operate.

The e^{th} control message is scheduled to be transmitted at time tₑ, and the other receivers begin a recovery process if they do not receive the message within the maximum propagation time. The maximum allowed recovery time for the control message is T_{A}=(nₘₐₓ+½)T_{R}, where T_{R} is the time between recovery attempts, and nₘₐₓ is the maximum number of recovery attempts before giving up. The control messages that are transferred after tₑ+T_{A} include a vote on whether the control message at tₑ was transmitted. If there are m receivers in the group, at tₑ+2T_{A}+mΔ_{T}, then all of the receivers have voted, and the control messages with the votes have been recovered by all of the receivers that can recover the control messages. The vote is then tallied at each of the receivers. A similar vote is started for the messages acknowledged by the eth control message to decide which messages are included in the final sequence. That vote is started at time tₑ+(2nₘₐₓ+½)T_{R}, which is the maximum time to recover the acknowledged messages after recovering the acknowledgment.

When the vote for the e^{th} control message is tallied, the following can occur:

If A(e) receivers received the e^{th} control message, B(e) receivers have not received the e^{th} control message, and C(e) receivers have left the group and have not voted, then

C(e)=mₑ−(A(e)+B(e)) (1)

where mₑ is the number of receivers in the group when the vote starts. If A(e)<mₑ/2, then the receiver that was scheduled to transmit the control message is voted out of the group, and it is not counted in mₑ in future votes.

Each receiver cannot receive all of the votes. At receiver rⱼ, Aⱼ (e)≦A(e), and Bⱼ(e)≦B(e). rⱼ required to make the correct decision or leave the group itself. At rⱼ, the following are considered.
If Aⱼ(e)≧mₑ/2, then A(e)≧mₑ/2, and rⱼ leaves the receiver that transmitted the e^{th} control message in the group.
If Bⱼ(e)>mₑ/2, then B(e)>mₑ/2, A(e)<mₑ/2, and rⱼ removes the receiver that transmitted e^{th} control message from the group.
If Bⱼ(e)−m_{e/}2 and Aⱼ(e)<m_{e/}2, then rⱼ is uncertain whether A(e)<m_{e/}2 and leaves the group itself
If Aⱼ(e)≅m_{e/}2, but rⱼ has not recovered the e^{th} control message, then rⱼ leaves the group.

One token round later, the receivers know which receivers have received the e^{th} control message and have remained in the group. If more than half of the receivers leave the group on a particular token passing round, then the group dissolves and is reformed by individual receivers joining a group with nearby receivers.

RNP can operate as an overlay on top of the overlapping M-RBP groups. An underlying M-RBP group includes all of the vehicles in an area, and the area covered by M-RBP group covers all or part of the neighborhoods of the vehicles in the area. A separate RNP operates in each vehicle and joins the messages from each of the M-RBP groups that cover its location. To provide the M-RBP guarantees to the neighborhood, each member of a vehicle's neighborhood must be in at least one of the M-RBP groups that cover the vehicle's location. One-dimensional overlays that are adequate for highways and the 2-D and 3-D extensions that are needed for airports and airspaces are described below.

As vehicles move, they can enter and leave neighborhoods and can change the M-RBP groups. In M-RBP, it takes more than a token rotation time to add a new vehicle to the group. The overlap of the M-RBP groups is selected so that the time that it takes to enter and delete vehicles from the M-RBP groups does not cause any delay when entering or removing vehicles from the neighborhoods in RNP, as described below.

The frequency with which vehicles enter and leave the M-RBP groups is reduced by having the groups move with the vehicles on a highway. However, the vehicles move with respect to one another and the groups change. A self-organizing algorithm that organizes groups around the vehicles is provided below.

A highway can be modeled as a 1-D network of vehicles that move with respect to one another. Depending on the application, the separate lanes on a highway can be modeled as parallel 1-D networks or as a single 1-D network.

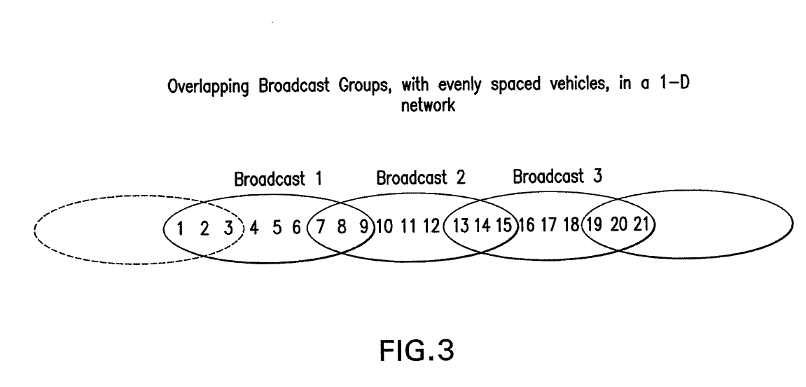

FIG. 3 shows an exemplary 1-D system that includes three M-RBP groups and 21 evenly spaced vehicles. A vehicle's neighborhood is the vehicles three in front and three behind the vehicle. For instance, vehicle 10's neighbors are vehicles 7, 8, and 9 and 11 to 13. Broadcast group 1 includes vehicles 1 to 9, group 2 includes vehicles 7 to 15, and group 3 includes vehicles 13 to 21. Vehicles 1, 2, 3, 7, 8, 9, 13, 14, 19, 20, and 21 each transmit all of their messages in two broadcast groups and receive all of the messages from both groups. The other vehicles only transmit and receive in a single broadcast group. With this overlap, every vehicle belongs to at least one broadcast group with each of its neighbors. For instance, vehicle 5 has all of its neighbors, which are vehicles 2 to 4 and 6 to 8 in group 1, whereas vehicle 8 has its neighbors 5, 6, 7, and 9 in group 1 and its neighbors 7, 9, 10, and 11 in group 2. Note that its neighbors 7 and 9 are in both broadcast groups.

From the example, it is clear that there are many arrangements of broadcast groups that can satisfy constraints on neighborhoods. On one extreme, there can be a single broadcast group that covers the entire highway. The disadvantages with this configuration are the following: 1) many of the guarantees are not provided until the token has cycled through all of the vehicles; 2) vehicles that participate in the group must receive or recover many messages which are not used; 3) powerful transmitters are required to have single-hop transmissions over the entire highway; and 4) there are a very large number of sources sharing the channel. The broadcast groups should be small.

At another extreme, each vehicle can have a broadcast group that covers its neighborhood. When a vehicle has neighbors, it belongs to Nₙ+1 broadcast groups. The disadvantage with this configuration is that each source message must be acknowledged in Nₙ+1 separate groups, and the sequences in the different groups must be coordinated. Messages should be transmitted in a small number of broadcast groups.

To quantify the differences between the configurations, the overlay efficiency ηₒᵥ can be defined as the number of new messages received from neighbors over the total number of messages received. Assuming that each vehicle transmits about the same number of messages:

ηₒᵥ=Averageᵥ[(Nₙ(v)/Σ_{vεBi}(N_{Bi}−1))] (2)

where v is a vehicle, Bᵢ are the broadcast groups that cover v, and N_{Bi} is the number of vehicles in Bᵢ. In a configuration with a single broadcast group, the number of vehicles on the highway is N_{H}>>Nₙ, and ηₒᵥ=(Nₙ/N_{H})→0. In the configuration with one broadcast group per vehicle, each vehicle receives messages, many of which are duplicates, from Nₙ vehicles in Nₙ+1 broadcast groups, ηₒᵥ=(Nₙ/Nₙ(Nₙ+1))=(1/Nₙ+1). In the example in FIG. 3 that presents an exemplary 1-D system, with one broadcast group per vehicle, Nₙ=6, and ηₒᵥ=0.14. In the configuration in the example N_{B}=9, one third of the vehicles belong to one group, and two thirds of the vehicles belong to two groups: ηₒᵥ=(⅓)( 6/8)+(⅔)( 6/16)=0.5. If the group size in the figure is reduced to 6, with the same overlap, then the efficiency increases to 0.6.

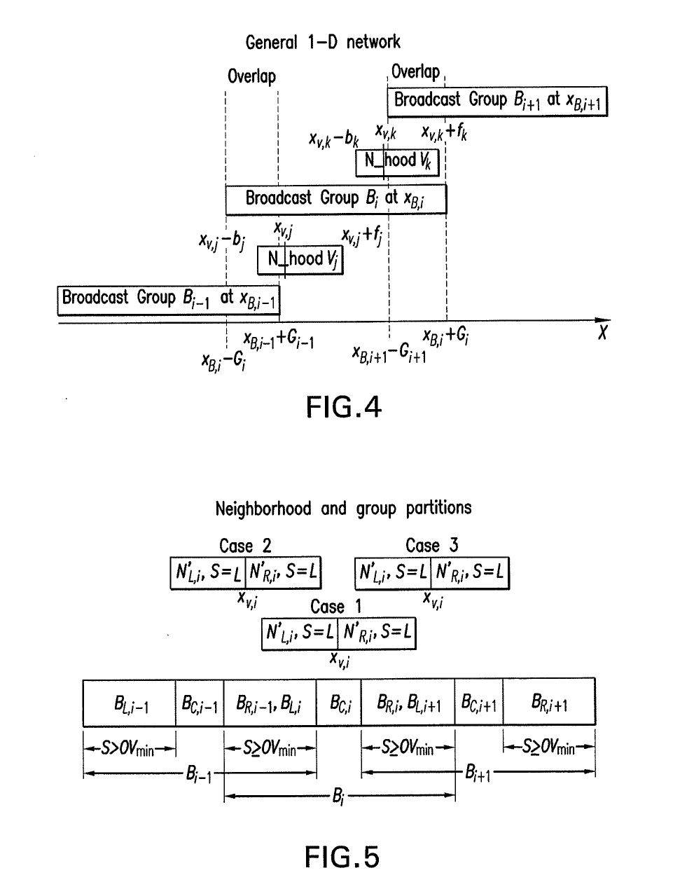

In general, vehicles and broadcast groups are not evenly spaced, a vehicle's neighborhood can extend further in one direction than another, and each of the groups and neighborhoods can have a different size, as shown in exemplary 1-D network in FIG. 4.

Next, an example of how to pick the group overlaps so that vehicles participate in at most two broadcast groups and can communicate with all of their neighbors without forwarding between groups will be described. Each vehicle participates in at most two groups when the maximum distance from the center to the edge of a group is less than the minimum distance between the centers of groups. Broadcast group B, is centered at location x_{B,i} and includes all of the vehicles at distance G, from x_{B,i} where:

Bᵢ=[_{xB,i}−G_{i,xB,i}+Gᵢ] (3)

where x_{B,i} is the center of broadcast group Bᵢ and Gᵢ is the span of broadcast group Bᵢ.
Without loss of generality:

x_{B,1}<x_{B,2}<x_{B,3}< (4)

The separation Sᵢ between the centers of two adjacent groups is:

Sᵢ=(x_{B,i+1}−x_{B,i}) (5)

where x_{B,i+1} is the center of broadcast group Bᵢ₊₁ and x_{B,i} is the center of broadcast group Bᵢ.
As long as Bᵢ₋₁ and Bᵢ₊₁ do not overlap for any i, at most, two broadcast groups cover any location. These two groups do not overlap when:

x_{B,i-1}+Gᵢ₋₁<x_{B,i+1}−Gᵢ₊₁ (6)

which can be rewritten as:

Gᵢ₋₁+Gᵢ₊₁<Sᵢ₋₁+Sᵢ (7)

where Gᵢ₋₁ is the span of broadcast group Bᵢ₋₁ and holds for all i when:

Gₘₐₓ<Sₘᵢₙ (8)

where Gₘₐₓ is the maximum span of the broadcast groups in the network and Sₘᵢₙ is the minimum separation between the centers of two adjacent groups in the network. In the remainder of this example:

Gₘₐₓ<Sₘᵢₙ (9)

so that none of the vehicles are in more than two broadcast groups. Any vehicle can communicate with all of its neighbors without forwarding between groups when the smallest overlap between groups is greater than the greatest distance between a vehicle and its neighbor. Vehicle Vⱼ is located at x_{V,j}. The vehicle's neighborhood Nⱼ includes all of the vehicles up to distance bⱼ behind it and distance fⱼ in front of it, and can be expressed as

Nⱼ=└xv,ⱼ−bⱼ,xv,ⱼ+f_{j┘} (10)

The overlap between adjacent groups is:

OVᵢ=(x_{B,i}+Gᵢ)−(x_{B,i+1}−Gᵢ₊₁) (11)

It is show that a vehicle can reach all of its neighbors as long as

OVₘᵢₙ>L (12)

where:

L=maxⱼ(bⱼ,fⱼ) (13)

and where L is the greatest distance from a vehicle to its neighbor.

A larger symmetric neighborhood can be defined as:

N′ⱼ=[x_{v,j}−L,x_{v,j}+L] (14)

where N′ⱼ is the symmetric neighborhood of vehicle Vⱼ.
If Vⱼ can reach any vehicle in N′ⱼ, then Vⱼ can reach any vehicle in Nⱼ. N′ⱼ can be viewed as a left-hand and a right-hand neighborhood, where the left-hand neighborhood defined as:

N′_{L,j}=[x_{v,j}−L,xᵥⱼ] (15)

where N′_{L, j} is the left-hand neighborhood of vehicle Vⱼ and the right-hand neighborhood N′_{R, j} defined as:

N′_{R,j}=[x_{v,j}·x_{v,j}+L] (16)

The size of N′_{L, j} and N′_{R, j} is L as shown in exemplary neighborhood and group partitions in FIG. 5.

When Gₘₐₓ<Sₘᵢₙ, at most two broadcast groups cover any region, and any Bᵢ can be broken into three distinct parts as follows:

1) a left-hand part B_{L,i} that overlaps Bᵢ₋₁;

2) a central part B_{C,i} that does not overlap with any other groups; and

3) a right-hand part B_{R,i} that overlaps Bᵢ₊₁, as shown in exemplary neighborhood and group partitions in FIG. 5. The size of B_{L,i} and B_{R,i} is ≧OVₘᵢₙ.

For a vehicle, x_{v, j ε B}ᵢ. 1) When x_{v, j} ε B_{C,i}, the vehicle is in the center of the group then all right-hand neighbors can be reached in Bᵢ because the distance from x_{v, j} to the right-hand edge of N′_{R, j} is L and the distance from x_{v, j} to the right-hand edge of Bᵢ is greater than the size of B_{R, i} which is ≧OVₘᵢₙ>L and all left-hand neighbors can be reached in Bᵢ because the distance from x_{v, j} to the left-hand edge of N′_{L, j} is L, and the distance from x_{v, j} to the left-hand edge of Bᵢ is greater than the size of B_{L,i}, which is ≧OVₘᵢₙ>L. 2) When x_{v, j} εB_{L,i}, the vehicle is in the overlap with Bᵢ₋₁ then all right-hand neighbors can be reached in Bᵢ because the distance from x_{v, j} to the right-hand edge of N′_{R, j} is L, and the distance from x_{v, j} to the right-hand edge of Bᵢ is greater than the size of B_{R, i}, which is ≧OVₘᵢₙ>L. Also, all left-hand neighbors can be reached in because the distance from x_{v, j} to the left-hand edge of N′_{R, j} is L, and the distance from x_{v, j} to the left-hand edge of Bᵢ₋₁ is greater than the size of B_{L,i} which is ≧OVₘᵢₙ>L. 3) When x_{v, j} ε B_{R,i}, all right-hand neighbors can be reached in Bᵢ₊₁, as in 2a and all left-hand neighbors can be reached in Bᵢ as in 2b.

The smallest overlap OV can be defined as:

OV=L+ε (17)

with this overlap, the smallest size group can be defined as:

2G=2*OV+ε=2L+ε (18)

With the smallest group size and smallest overlap, every vehicle is in two groups. When fᵢ=bᵢ=L, the neighborhood size equals the group size, and ηₒᵥ=0.5.

The broadcast groups are kept small, for efficiency. However, if a neighborhood ends near the edge of a broadcast group, then a vehicle that enters an area must first join the broadcast group before joining the neighborhood. Therefore, there is a delay before the vehicle can join the neighborhood. M-RBP continuously modifies the broadcast group, but it takes time to enter a new participant in the group. The new member transmits a message asking to join the group and must wait until the message is acknowledged and voted into the group. If the group size made larger than the minimum and used the extra coverage to increase the overlap, then mobile vehicles can be included in M-RBP group before they can join a neighborhood. In this way, a vehicle is never delayed when it enters a neighborhood.

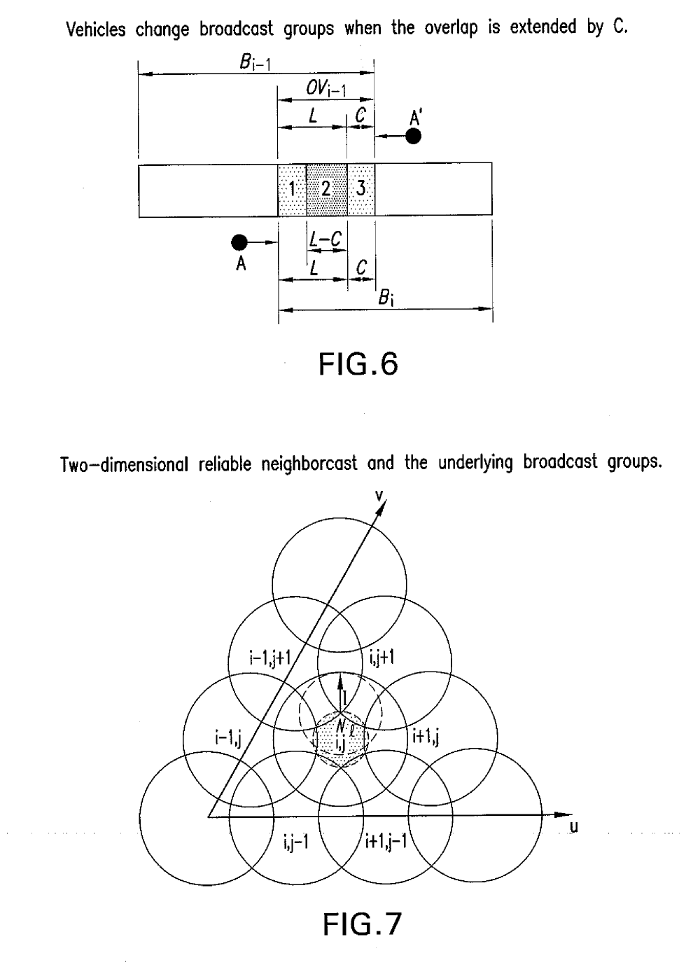

For example, let the overlap OV=L+C. In exemplary case presented in FIG. 6, where vehicles change broadcast groups when the overlap is extended by C, the overlap consists of regions 1, 2, and 3. Regions 1 and 3 are C long, and region 2 is L−C long. Vehicle A enters broadcast group B, when it enters region 1. However, all of its neighbors are in broadcast group Bᵢ₋₁ until it enters region 2, since the size of regions 2+3 is L. Once vehicle A enters region 2, some of its neighbors can only be in group B, and it must be included in that group to communicate with those neighbors. Vehicle A has the time it takes to cover distance C to join Bᵢ. Similarly, when vehicle A′ enters region 3, it has the time it takes to enter region 2 before some of its neighbors can only be in Bᵢ₋₁.

The size of C depends on the time it takes to enter a vehicle into a broadcast group and the time it takes for a vehicle to cross a region of size C. For instance, assume that it takes at most 5 s to enter vehicles into a broadcast group. If the broadcast groups are stationary and the vehicles are moving at 50 ml/h, then the vehicles can travel about 75 ft in 5 s. Therefore, C is 75 ft. However, if the broadcast groups are moving with the average speed of the vehicles instead of being stationary and vehicles travel within 5 ml/h of the average speed, then the value of C is about 7.5 ft, which is only ( 1/10)^{th} the value for stationary groups.

The region C decreases the efficiency ηₒᵥ by increasing the size of the broadcast groups, whereas the size of the neighborhood remains the same. The decrease in efficiency is greater for stationary groups than for moving groups. Therefore, it can be advantageous to have the groups move with the vehicles.

In a highway application, stationary groups can be located at fixed intervals with respect to mileage markers. Locating and spacing moving groups is more challenging than locating stationary groups. A self-organizing procedure required that moves the groups at the average speed of the vehicles, changes the size and center of the groups as vehicles move relative to one another, adjusts the size of adjacent groups toward the desired value, and adds and deletes broadcast groups when necessary. Such a procedure is described herein that uses the characteristics of M-RBP to manage moving groups.

1) Functions Performed by the Vehicles: The vehicles in a broadcast group are responsible for moving the center of the group as the vehicles move, expanding the size of a group to cover vehicles that move at different speeds, splitting groups that become too large, joining groups that become too small, and starting new groups when necessary. The rules for changing the broadcast group are independently executed at each vehicle. The vehicle reports its suggested change to the group when it transmits its token, and the change does not take place until the token is voted into the list by the M-RBP voting procedure. The vehicle can also send a source message to the group if it must issue a change when it does not have the token. A source message, which is transmitted by a vehicle in the overlap, is used to merge two adjacent groups and simultaneously notify the members of both groups. The source message must also go through the M-RBP voting procedure before the change takes effect.

Each time a vehicle transfers the token, it broadcasts its current location to all of the members of its broadcast group. It is assumed that a vehicle in Bᵢ knows the current center x_{B, i} and span Gᵢ of the broadcast group, the last reported locations of each vehicle in Bᵢ, and the transmission time of the token that reported the location. Furthermore, a vehicle in the overlap OVᵢ between Bᵢ and Bᵢ₊₁ has the information on both groups.

When a vehicle transmits a token at time tₑ, it can use its local information to change the size or center of its broadcast group. The change does not take effect until the vote is tallied at:

tᵥ=tₑ+2T_{A}+mₑΔ_{T} (19)

where tᵥ is the time when the vote for the token is tallied, tₑ is the time when the token is transmitted, T_{A} is the maximum allowed recovery time for the control message, mₑ is the number of receivers in the group and Δ_{T} is the token is passed every Δ_{T} seconds.
To compensate for this delay and possibly outdated information on vehicle locations, the vehicle can use the predicted position of the vehicles at the time the change will take effect, assuming that the vehicles travel at a constant speed. For instance, if the last two times that vehicle Vᵢ transfers the token in Bᵢ is t₁ and t₂, and reports its locations as x₁ and x₂, and vehicle Vⱼ uses the location of Vᵢ to cause a change that will take effect at time tᵥ, then the location that Vⱼ uses for Vᵢ can be expressed as:

x_{v,i}=x₂+(x₂−x₁)(tᵥ−t₂)/(t₂−t₁) (20)

where x₁ is the first reported location of vehicle Vᵢ, x₂ is the second reported location of vehicle Vᵢ, t₁ is the time when vehicle Vᵢ transmits the token and reports its first location and t₂ is the time when vehicle Vᵢ transmits the token and reports its second location. By using the last three reports from Vᵢ, Vⱼ could also estimate Vᵢ's acceleration and make a more accurate estimates of its position.

Vehicles can adjust a group's position and size to maintain a target overlap between adjacent groups and a target group size. The target overlap can be described by the equation:

OV_{T}=L+C+Δ (21)

where L is the overlap to guarantee that a vehicle can communicate with all of its neighbors, C is the additional overlap to allow vehicles to enter an underlying broadcast group before entering a neighborhood, Δ is an additional overlap to prevent vehicles near the boundary of a group from rapidly moving in and out of the group as the boundary moves.

A vehicle does not start to join a new group until it is A past the boundary. The additional overlap provides hysteresis and stops vehicles from rapidly joining and leaving groups with small changes in the group boundaries. The target broadcast group size can be determined by the equation:

G=OV_{T}+η (22)

where OV_{T} is the target overlap size that we want to maintain between any two adjacent groups and η is the part of the broadcast group that does not overlap with any other broadcast group.

2) Starting New Broadcast Groups: Vehicles can start new broadcast groups whenever they are in a region without broadcast groups and when they are near the boundary of a single broadcast group. When a vehicle is not covered by any broadcast groups, it starts a broadcast group with its location as the center, and can be determined by equation (22).

The vehicle periodically transmits a token, with the location and span of the group, as an invitation for other vehicles to join the group. When a vehicle is covered by only one broadcast group and it is within OV_{T} of an edge of the group it starts a second broadcast group that overlaps the first group by OV_{T}, with itself in the overlap.

3) Moving the Broadcast Groups With the Vehicles: All of the vehicles in a group move the group every time they pass the token. When a group moves, its size can change. If the size becomes large enough to encompass two target group sizes with a target overlap, then the group is split in two. If a group size decreases to the point where locations are covered by more than two groups, then two of the overlapping groups that were adjacent are joined.

To move a broadcast group, a vehicle in B, with the token determines x_{V, min} ε B, and x_{V, max} ε Bᵢ, the smallest and largest predicted positions for vehicles when the vote on the token message is tallied. The vehicles use these positions and the current edges of the groups to determine the new span of the group, from xₘᵢₙ to xₘₐₓ. The calculation that a vehicle performs depends on whether the vehicle has information about an adjacent group.

If the vehicle is not in the overlap with or Bᵢ₋₁ or Bᵢ₊₁, then the vehicle can calculate the left-hand edge of the group using the equation:

xₘᵢₙ=min[x_{V,min,}x_{B,i}−Gᵢ] (23)

and then the vehicle can calculate the right-hand edge of the group using the equation:

xₘₐₓ=max[x_{V,max,}x_{B,i}−Gᵢ] (24)

Consecutively, all of the vehicles remain in the group, the left-hand edge of the group can only move to the left, increasing the overlap with Bᵢ₋₁. Furthermore, the right-hand edge of the group can only move to the right, increasing the overlap with Bᵢ₊₁ and the group size can only increase. If the vehicle is in the overlap with Bᵢ₋₁ then the vehicle can calculate the left-hand edge of the group using the equation:

xₘᵢₙ=min[x_{V,min},x_{B,i-1}+Gᵢ₋₁−OV_{T}] (25)

and then the vehicle can calculate the right-hand edge of the group using the equation:

xₘₐₓ=max[x_{V,max},x_{B,i}+Gᵢ] (26)

Consecutively, all of the vehicles remain in the group, the left-hand edge of the group can move to the left or the right. It moves to the right when all of the vehicles in the group vacate part of the overlap, and the target overlap can be maintained. The right-hand edge of the group can only move to the right, increasing the overlap with Bᵢ₊₁ and the group size can increase or decrease. If the vehicle is in the overlap with Bᵢ₊₁, then the vehicle can calculate the left-hand edge of the group using the equation:

xₘᵢₙ=min[x_{V,min},x_{B,i}+Gᵢ] (27)

and then the vehicle can calculate the right-hand edge of the group using the equation:

xₘₐₓ=max[x_{V,max},x_{B,i+1}−Gᵢ₊₁+OV_{T}] (28)

Consecutively, all of the vehicles remain in the group, the left-hand edge of the group can only move to the left, increasing the overlap with Bᵢ₋₁, the right-hand edge of the group can move to the right or left. It moves to the left when all of the vehicles in the group vacate part of the overlap, and the target overlap can be maintained. The group size can increase or decrease.

The vehicle can calculate the new center of the group using the equation:

x′_{B,i}=(xₘₐₓ+xₘᵢₙ/2) (29)

and new span of the group can be calculated using the equation:

G′ᵢ=maxᵢ[Gᵢ,(xₘₐₓ−xₘᵢₙ/2)] (30)

These values are included in the acknowledgment message.

4) Splitting Groups: All of the vehicles can determine when a group is large enough to be split into two groups. If 2G′ᵢ>3OV_{T}+4η, then the group can be split into two groups with Gᵢ^{new}>OV_{T}+η and an overlap between the groups of OV_{T}. The centers of the groups are at x_{i, 1}^{new}=x′ᵢ+((G′ᵢ−OV_{T}/2)/2) and x_{i, 2}^{new}=x′ᵢ−((G′ᵢ−OV_{T}/2)/2). The span of the new groups are G_{i, 1}^{new}==G_{i, 2}^{new}=((G′ᵢ+OV_{T}/2)/2). When a broadcast group is split, the change will not take effect until the vote on the token that instructs the split is tallied. At that time, all of the vehicles in the group know that it will be split.

5) Joining Two Adjacent Groups: Vehicles in the overlap between two broadcast groups Bᵢ and Bᵢ₊₁ are responsible for joining groups when the edge of one group covers the center of another group. This condition can result in more than two groups covering a position. As long as the edge of a group cannot cover the center of an adjacent group, three groups cannot cover the same position. When x_{B, i+1}−Gᵢ₊₁≦x_{B, i}+Gᵢ≧x_{B, i+1}, the center of one group is covered by the edge of the other. The groups are joined with the center at:

((xᵢ−Gᵢ)+(xᵢ₊₁+1+Gᵢ₊₁)/2 and G=((xᵢ₊₁+Gᵢ₊₁)−(xᵢ−Gᵢ)/2 (31)

so that the new group covers the area of the two groups.

The vehicle in the overlap simultaneously transmits a source message in both groups with instructions not to use the new groups until a time when the vehicle believes that the vote on the source messages in both groups will be complete. If the new group is larger than the maximum size target group because one group was much larger than the other, then it will be divided into two equal size groups by the first token in the new group.

The RNP overlay processes the messages from one or more broadcast groups and passes those messages to the application. The broadcast groups include messages that are from vehicles that are not in this vehicle's neighborhood, these messages are filtered out. Some messages are received from more than one of the broadcast groups, the duplicate messages are removed. Finally, when two messages appear in more than one broadcast group, the messages can be in a different order in the two groups. This can happen when the first message is retransmitted in one of the groups.

Complete sequencing over the entire network is an unnecessary burden, since no vehicles receive most of the messages. Partial sequencing is defined as two messages having the same order at any vehicles that must receive both. There are several techniques to convert different orders in two broadcast groups into the same sequence.

One technique first synchronizes the numbers of the acknowledgments so that acknowledgments in different groups that occur at approximately the same time have the same sequence number. When a source message is acknowledged by different acknowledgment numbers in different groups, the source sends a new broadcast message to move the original message to the earlier sequence number. The possibility of moving a message increases the time until a message can be dependably sequenced.

Intersections of roads, switches on a railroad, and the surface of an airport require a 2-D network, and control of airspace requires a 3-D network. The overlaps of 2-D groups are overlapping circles, and the overlaps for 3-D groups are overlapping spheres. In a 2-D network, a vehicle can need to belong to as many as three underlying broadcast groups to communicate with all of its neighbors. In addition, in a 3-D network, a vehicle can need to belong to as many as four underlying broadcast groups to communicate with all of its neighbors.

When vehicles can randomly move through a 2-D or 3-D area, the underlying broadcast groups must be stationary. Groups can be used that move with the vehicles by restricting the motion so that all vehicles in an area travel in the same direction. Airplanes in a 3-D airspace travel in the same direction at different elevations.

In a 2-D application, the neighborhood N, can have irregular shapes, but it must contain the vehicle Vᵢ at location (xᵢ, yᵢ). Similar to the symmetric neighborhood in the 1-D example, a neighborhood N′ᵢ can be defined that is a circle with radius L that is the maximum distance from Vᵢ to the edge of Nᵢ for all i. If it can be communicated with any vehicle in N′ᵢ, then it can communicated with any vehicle in Nᵢ because Nᵢ ⊂ N′ᵢ.

FIG. 7 shows an exemplary two-dimensional reliable broadcast and the underlying broadcast groups. In FIG. 7, the centers of equal size underlying broadcast groups are equally spaced along the (u, v) axis. The (u, v) axis are at a 60° angle with respect to one another and are commonly used to space base stations in a cellular network on an unobstructed plane. The broadcast groups are the solid circles with radius r. The centers of the broadcast groups are located s apart. When r<\sqrt{3} at most three broadcast groups cover a location.

The shaded circle is the symmetric neighborhood N′ₖ with radius L, for vehicle Vₖ. If a dashed circle is drawn with radius y=r−L, when the center of the neighborhood is within the dashed circle, then all of the neighbors of Vₖ can be reached in broadcast group (i, j). When Vₖ is outside the dashed circle but within B_{i,j}, some of the neighbors are outside B_{i,j}, and Vₖ must also be in the other broadcast group to communicate with those neighbors.

When the dashed circle includes the cusp of the circles that intersects in B_{i,j}, any Vₖ that is outside the dashed circle is in multiple broadcast groups and can communicate with any vehicle in N′^{k} in one or more of the broadcast groups that cover its location. The dashed circles include the cusps when:

y≧(s/2)\sqrt{3}−\sqrt{r²−(s/2)²} (32)

Since y=L−r, there are constraints on L, r, and s that guarantee communications within a neighborhood. If L′<L defines the symmetric neighborhood, then C=L−L′ is the distance that a vehicle can traverse before it must join a new broadcast group.

In three dimensions, the transmission regions are equally spaced spheres. The symmetric neighborhood N′ is a sphere with radius L equal to the distance to the furthest vehicle that is considered a neighbor. There is the same construction with an inner sphere whose radius is large enough to include the cusp of spheres that intersects within a transmission radius. The cusp is formed by three spheres, and there can be four broadcast groups covering a vehicle's position.

It will be understood that the foregoing is only illustrative of the principles of the disclosed subject matter, and that various modifications can be made by those skilled in the art without departing from the scope and spirit of the disclosed subject matter. For example, the system and methods described herein have been used primarily for modeling a one-dimensional overlapping vehicle-to-vehicle broadcast group. It will be understood by the skilled artisan that a reliable neighborhood protocol (RNP) as described herein is also useful in connection with modeling and/or implementing two- and three-dimensional overlapping broadcast groups. Moreover, individual features of the exemplary embodiments described herein can be combined and/or rearranged to create new embodiments.

We claim:

1. A method for exchanging vehicle information between a plurality of moving vehicles, the method comprising:
(a) creating one or more broadcasting groups, where each group represents one or more of said plurality of moving vehicles;
(b) forming one or more neighborhoods, each representing two or more vehicles from said one or more broadcasting groups;
(c) transmitting information about a first vehicle in a first of said one or more neighborhoods to at least one or more different vehicles from said one or more moving broadcasting groups; and
(d) using said transmitted information at one or more vehicles, if any, located within said first neighborhood.

2. The method of claim 1, wherein creating one or more broadcasting groups comprises:
(a) broadcasting a token from a first of said plurality of vehicles as an invitation to one or more other vehicles of said plurality of vehicles to join a proposed broadcasting group, said token including information on a center and a span of said proposed broadcasting group corresponding to said first vehicle;
(b) sending a request from at least on of said one or more other vehicles to said first vehicle to join said proposed broadcasting group; and
(c) accepting at least one of said requests, thereby forming a first of said one or more broadcasting groups corresponding to said proposed broadcasting group.

3. The method of claim 1, each of said one or more neighborhoods having a center, and wherein said forming for each of said one or more neighborhoods comprises including two or more vehicles from one or more broadcasting groups that are within a predetermined distance from a vehicle corresponding to a center for said neighborhood.

4. The method of claim 3, wherein said transmitting information comprises transmitting information from said vehicle corresponding to said center to each vehicle in said neighborhood is guaranteed.

5. The method of claim 4, wherein duplicate information is transmitted and wherein said duplicate information is filtered out by said vehicle corresponding to said center.

6. The method of claim 1, wherein said transmitted information is selected from the group consisting of speed, position, direction, acceleration and state.

7. The method of claim 1, wherein said using said transmitted information further comprises coordinating relative motion of a first of said vehicles located within a first of said one or more neighborhoods with each other vehicle located within said first neighborhood.

8. The method of claim 1, each of said one or more broadcasting groups having a span, and wherein said using said transmitted information further comprises adjusting a span of at least a first and a second of said one or more groups and maintaining a minimum overlap between said first group and said second group.

9. The method of claim 8, wherein said minimum overlap size is determined to avoid causing delay to vehicles located within a neighborhood representing vehicles from said first and/or second groups.

10. A system for exchanging vehicle information between a plurality of moving vehicles, the system comprising:
a processing unit adapted to be operatively coupled to a first vehicle, a wireless connection device operatively coupled to said processing unit, at least one sensor, operatively coupled to said processing unit, for sensing information about said first vehicle, and a memory operatively coupled to said processor unit and storing program instructions that when executed by said processor, cause said processor to:
(a) create one or more broadcasting groups, where each group represents one or more of said plurality of moving vehicles, including said first vehicle;
(b) form one or more neighborhoods, each representing two or more vehicles from said one or more broadcasting groups, wherein at least a first of said one or more neighborhoods represents vehicles which include said first vehicle; and
(c) transmit information using said wireless connection device about a said first vehicle in said first neighborhood to one or more different vehicles from said one or more moving broadcasting groups.

11. The system of claim 10, wherein said sensor is selected from the group consisting of speed, position, direction, acceleration and state sensors.

12. The system of claim 10, wherein said processor further comprises program instructions for coordinating relative motion of said first vehicle with each other vehicle located within said first neighborhood.

13. The system of claim 10, each of said one or more broadcasting groups having a span, wherein said processor further comprises program instructions to maintain a minimum overlap size between said first vehicle and at least a second vehicle located within said first neighborhood.

14. The system of claim 13, wherein said processor further comprises program instructions to guarantee delivery of said transmitted information between said first vehicle to each vehicle in said first neighborhood.

15. The system of claim 14, wherein said processor further comprises program instructions to filter out duplicate information, if any, received from any vehicle that are not in said first neighborhood.

16. The system of claim 10, further comprises a global navigation positioning device, operatively coupled to said processor, for receiving information about position of at least said first vehicle.

17. A system for exchanging vehicle information between a plurality of moving vehicles, the system comprising:
(a) means for creating one or more moving broadcasting groups, where each group represents one or more of said plurality of moving vehicles including a first vehicle;
(b) means, coupled to said creating means, for forming one or more neighborhoods, each representing two or more vehicles from said one or more broadcasting groups, wherein at least a first of said one or more neighborhoods represents vehicles which include said first vehicle; and
(c) means, coupled to said forming means, for sensing information about said first vehicle and means, coupled to said sensing means, for transmitting in said first neighborhood to one or more different vehicles from said one or more moving broadcasting groups.

18. The system of claim 17, wherein said sensing means is selected from the group consisting of speed, position, direction, acceleration and state sensors.

19. The system of claim 17, wherein said transmitting means comprises conveying data over wireless channels of infrastructure-less, ad hoc networks.

20. The system of claim 17, wherein said transmitting means comprises conveying as individual messages.
